(19) United States
(12) Patent Application Publication
(10) Pub. No.: US 2007/0192214 A1
(43) Pub. Date: Aug. 16, 2007

(54) Method and apparatus to signal rental asset use completion

(76) Inventor: Thomas F. Doyle, San Diego, CA (US)

Correspondence Address: QUALCOMM INCORPORATED, 5775 MOREHOUSE DR., SAN DIEGO, CA, 92121, US

(21) Appl. No.: 11/346,012

(22) Filed: Feb. 1, 2006

(51) Int. Cl. G06Q 10/00

(52) U.S. Cl. 705/28

(57) ABSTRACT

An apparatus and method to provide rental status indication includes a user interface to allow a user to input that the rental asset is no longer in use. On indication from a user that the rental status is no longer in use, a sensor determines if the asset is in fact not in use based on predetermined criteria. If the asset is not in use, a signal is sent to the rental agency indicating the same.

### BACKGROUND

1. Field

Disclosed are methods and apparatuses related to asset usage and rental, and more particularly, methods and apparatuses to signal a rental agency that the renter has completed use of the rental asset.

2. Background

Construction companies often rent heavy equipment, such as, for example, bull dozers, backhoes, cranes, forklifts, and the like, instead of purchasing the equipment. The construction companies contract with a rental agency who delivers the rental equipment and picks up the rental equipment once the construction company is finished with the rented equipment. The rental company delivers and picks up the equipment because special transports and licenses are often necessary to transport the often slow moving construction heavy equipment.

In practice, the rental company charges for the heavy equipment from a start time, which may be when the asset is delivered, to a completion time. Traditionally, completion time is determined by when the construction company alerts the rental company that it is done with the asset, and the rental company can come pick up the asset.

Frequently, the construction company actually calls the rental company prior to completion of use of the rental asset knowing that the rental company cannot immediately send a transport to pick up the asset. Thus, for example, a construction company renting a crane may call the rental company at 6:00 PM on a Friday evening to indicate the use of the rental equipment is completed. The rental company acknowledges the information and ceases billing the construction company for the rental. However, believing that that the rental company will not pick up the unit for several hours, or even until the next day, the construction company continues to use the asset. This use is not billed to the construction company.

Thus, it would be desirous to develop a rental asset completion indication that address the above and other issues.

### SUMMARY

A method for providing rental status indication is provided. The method comprises providing an operator initiated rental asset completion signal to a processor associated with the rental asset. On receiving the rental asset completion signal at the processor from, determining whether the rental asset is not in use by looking at objective indicia. If it is determined the rental asset is not in use, generating a rental status signal. And transmitting the rental status signal to the rental agency indicating rental completion.

An apparatus to provide indication also is provided. The apparatus includes a processor with a user interface including at least a switch. The switch coupled to the process to provide an operator initiated indication that the use of the rental asset is complete. A sensor a sensor coupled to the processor monitors at least one operating characteristic of the rental asset to provide confirmation that the use of the rental asset is complete. If the asset is determined not to be in use, a transmitter coupled to the processor to transmit a rental status signal to the rental agency. When an operator uses the switch to indicate the use of the rental asset is complete, the processor confirms the monitored at least one operating characteristic indicates use of the rental asset is complete and based on the confirmation, causes the transmitter to transmit the rental status signal indicating the use of the rental asset is complete.

### BRIEF DESCRIPTION OF THE DRAWINGS

FIG. 1 is a functional block diagram of a system;

FIG. 2 is a block diagram of the operator interface of FIG. 1 in more detail;

FIG. 3 is a flowchart illustrating a method of operation; and

FIG. 4 is a flowchart illustrating a method of operation.

### DETAILED DESCRIPTION

While the description below generally describes construction related heavy equipment, the methods, apparatuses, and systems disclosed herein may be used in multiple environments. Other examples, include, for example, cars, home appliance rental, and the like.

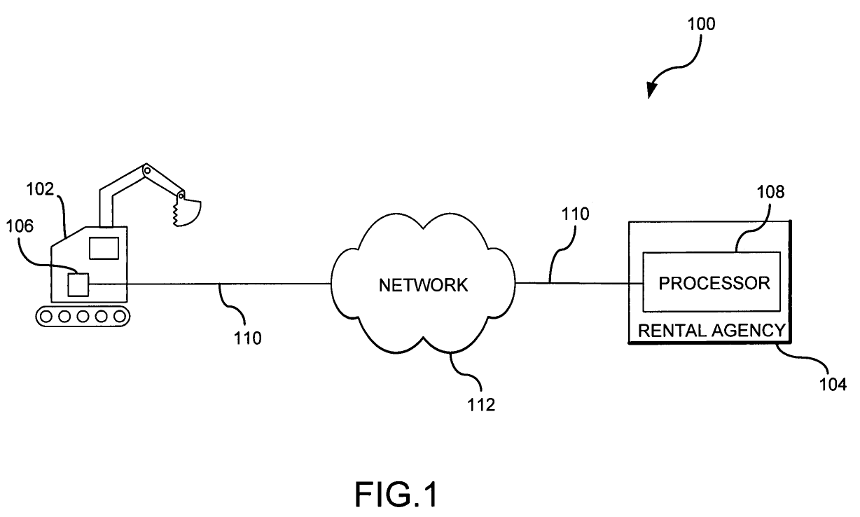

Referring first to FIG. 1, a system 100 is shown. System 100 includes a rental asset 102 and a rental agency 104. Rental asset 102 would have an operator interface 106 coupled to a processor 108 at rental agency 104 over a data link 110 through a network 112. Network 112 could be any type of network including, for example, a PSTN, a LAN, a WAN, a WiFi, a LWAN, a wireless communication network, or the like. By way of non limiting example, system 100 will be described as if network 112 is a wireless communication network. Similarly, data link 110 would correspond to network 112 and, in this non limiting example, is a wireless signal. Processor 108 could be any type of processor including a wireless communication device, a laptop computer, a desktop computer, a server, a mainframe, a portable digital assistant, or the like. Finally, while system 100 is described as if instant or continuous communication was available, system 100 could operate in or by batch transmission of data.

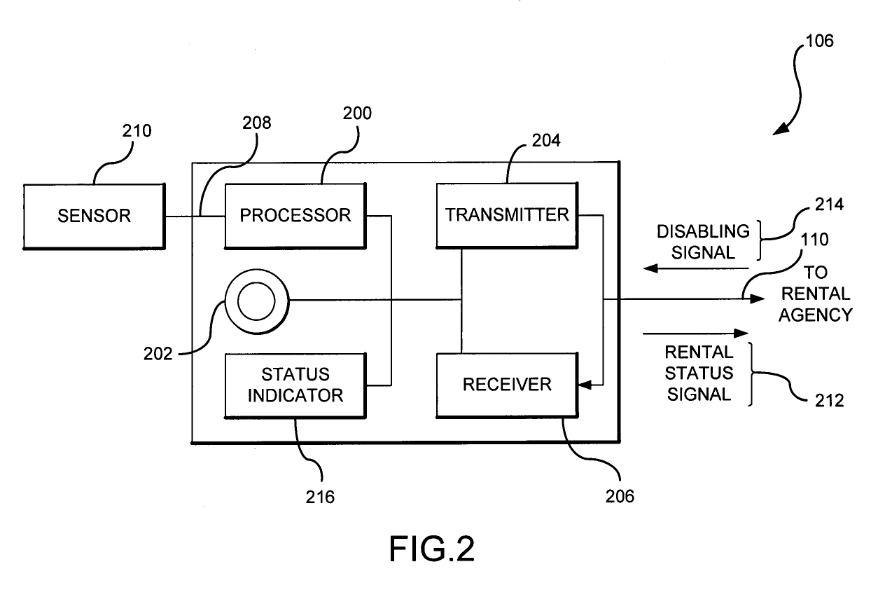

Referring to FIG. 2, operator interface 106 is shown in more detail. Operator interface 106 includes a processor 200. Processor 200 is coupled to a switch 202, a transmitter 204, optionally a receiver 206, and a sensor 210 through a sensor input 208 or port. While transmitter 204 and optional receiver 205 are described separately, they could be combined into a single transceiver as desired. Processor 200 may be coupled to a status indicator 216. Processor 200 could be any conventional processor, such as, for example, a chip set, a microprocessor, a computer, a server, or the like. Status indicator could be a display, a light, a tone, or the like.

Switch 202 should be construed broadly and may include, for example, a manually activated switch, such as, for example, a throw switch or a push button switch, an electronic or software switch, such as, for a graphical user interface operating with a program to generate an on/off type signal, or other switches as are generally known in the art. Switch 202 provides an operator initiated rental status to processor 200 that would initiate an application in processor 200 to generate and transmit a rental status signal 212 over data link 110. In this case, rental status signal 212 would indicate completion of the rental. Rental status signal 212 would be received by processor 108 at rental agency 104. Processor 108 would update the billing system of rental agency 104 to cease billing the asset and generate an invoice. The above described switch 202 is useful for a basic indication of rental status. FIG. 5, below, shows a user interface 500 that may be useful for updating rental status of an asset to allow a user to indicate cost centers, different jobs, rental off and on line, etc., as will be explained further below.

While providing an efficient and convenient mechanism to alert the rental agency that the renter is done with the asset, the system does not solve the problems identified above as the renter can signal completion and continue to use the asset. Rental agencies for sometime have suggested providing a disabling signal 214 from processor 108 to operator interface 106 over data link 110. Disabling signal 214 would cause rental asset 102 to cease functioning. Although this would solve the problem of using the assert after indication being done, it does not account for inadvertent toggling of switch 202 and other such issues that could cause hazardous situations if the asset is disabled.

Thus, operator interface 106 has sensor input 208 coupled to sensor 210. Sensor 210 could be an appropriate indicator of whether the unit is still in operation, such as, for example, engine rpm, truck bed load, speed, or the like. In other words, sensor 210 is capable of monitoring operating characteristics of rental asset 102. Thus, when switch 202 is activated, and processor 200 initiates the program, but instead of immediately generating and sending rental status signal 212, processor 200 checks sensor input 208 to determine whether sensor 210 indicates asset 102 is in fact not being operated. Processor 200 only sends a rental completion status if both the toggle and the sensor indicate the rental asset is, for example, idle, off, or the like. Because processor 200 only sends the completion signal with two positive indications of completion, sensor 210 indicating the rental was not in use, does not case rental status signal 212 indicating completion to be sent.

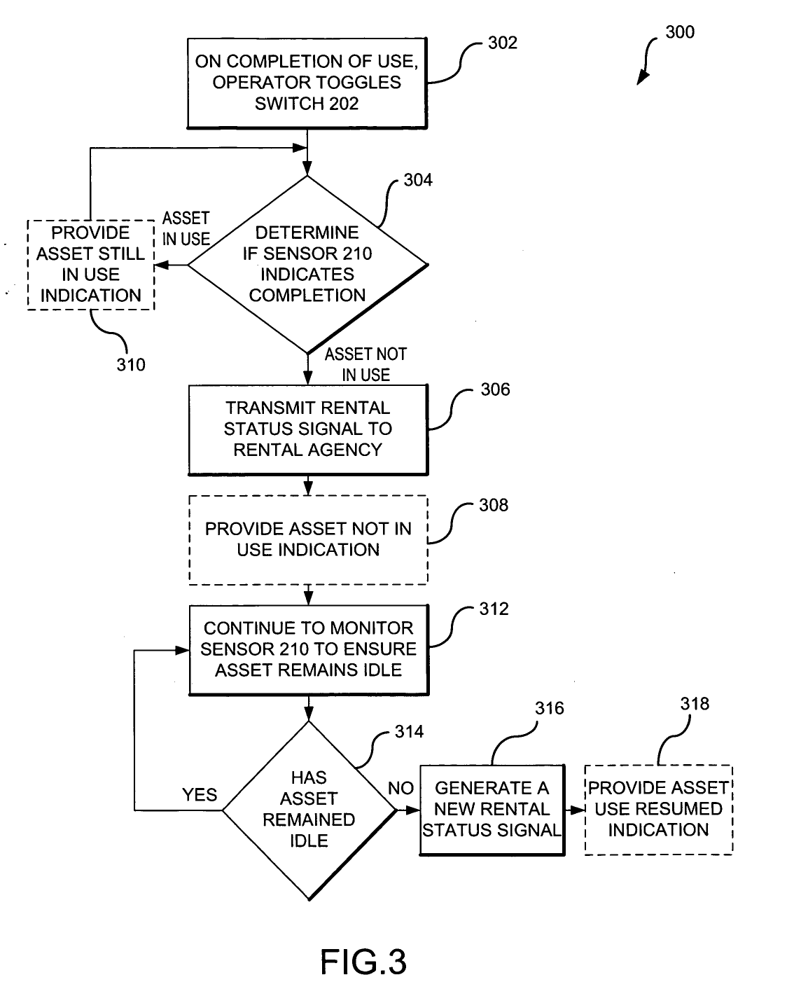

Operation of system 100 will now be explained with reference to FIG. 3 and flowchart 300. First, on completion of the use of the rental asset, the operator or user would toggle switch 202, step 302. Processor 302 would then determine whether sensor 210 confirms that the rental asset is not in use, step 304. The determination step could operate on a time delay or other predetermined threshold. For example, if engine rpm was the appropriate sensor input, and the engine continued to operate over a cool down period, processor 200 check the rpm signal after the cool down period to determine whether the asset is not in use. Alternatively, if the asset continues to idle after use, processor 200 may conclude sensor 210 indicates the asset is not being used if rpms are below a particular threshold value. If it is determined that the rental asset is no longer in use, processor 200 would cause transmitter 204 to transmit rental status signal 212 indicating completion, step 306. Optionally, processor 200 may cause status indicator 216 to indicate rental not in use or the like, step 308.

As can be appreciated, once switch 202 is toggled to indicate rental use is done, the system takes some time to determine whether the other indicia confirm (or deny) the rental use is actually done. During this time, processor 200 may cause indicator 216 to provide a determining indicator. For example, if the rental use is completed and confirmed, indicator 216 may illuminate a steady light. Whereas after toggling switch 202 but prior to confirmation, indicator 216 may blink. The continuous and blinking light are exemplary and non-limiting examples. In this case, if an operator toggles switch 202 but continues to use the asset, indicator 216 would initially blink and then turn off as the system determined the asset was still in use. Alternatively, a second indicator may be provided to indicate asset continued in use. The second indicator is similar to indicator 216 and not described in detail.

If it is determined the asset is still in use, optionally, processor 200 repeats step 304 and continues to monitor sensor 210 until sensor 210 actually indicates completion of use of the rental asset. During this time, processor 200 may provide a status on status indicator 216 indicating the asset is still considered in use by rental agency 104, step 310. As mentioned above, this could be through a second indicator.

If the rental status signal 212 indicating completion is transmitted, processor 200 may continue to monitor sensor 210 to ensure asset 102 remains idle, step 312. Based on the monitoring, processor 200 would determine whether the asset is in fact still being used, step 314. Steps 312 and 314 would continue until asset 102 is retrieved by the rental agency. For example, if engine rpms rose above a predetermined value. Based on the determination that the asset is being used, processor 200 would cause transmitter 204 to generate a new rental status signal 212, step 316. New rental status signal would indicate rental status as active, or the like, which would cause rental agency 104 to resume billing or the like. Although actually billing may occur after a predetermined time delay. Processor 200 may provide a new status indication to status indicator 216 showing the asset to be in use again to alert the operator that billing has resumed, step 318.

Furthermore, and optionally, once it is determined asset 102 is not being used, disabling signal 214 may be sent to asset 102, step 320. The disabling signal may be sent immediately, after a predetermined time period, or based on other criteria. If a disabling signal is sent and received, the process ends, step 322.

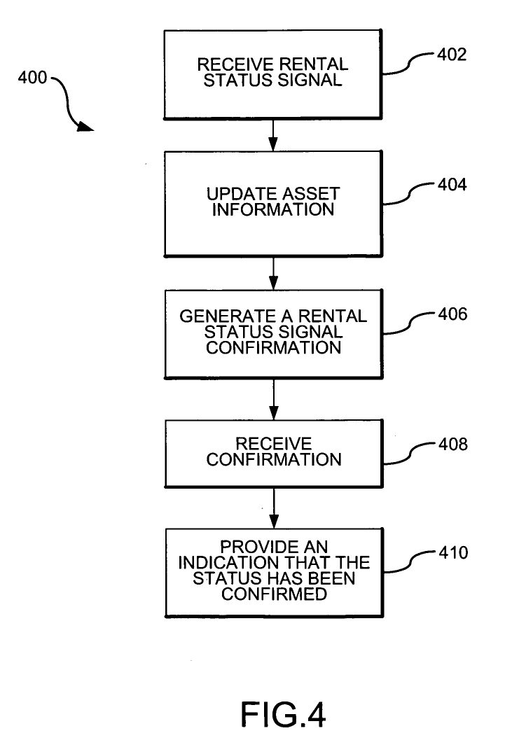

Optionally, as shown by FIG. 4 and flowchart 400, a rental status confirmation signal may be provided from the rental agency to the operator. First, processor 108 would receive rental status signal 212 from operator interface 106, step 402. Processor 108 would update the asset information based on the rental status signal 212, step 404. Once the asset information is properly updated, processor 108 would generate a rental status signal confirmation signal, step 406, which would be received by receiver 206, step 408. Processor 200 could use the rental status confirmation signal to indicate at status indicator 216 that the agency has received and processed the rental status signal, step 410. This would provide confirmation to the operator that, for example, the agency has ceased billing for the asset.

Referring to FIG. 5, a user interface 500 is shown. User interface 500 may include a input 502 and a display 504. Input 502 may include a touch screen, a light pen, a mouse with menus and hyperlinks, or any conventional input device. Display 504 may include a CRT screen, a flat screen, a LEDs, liquid crystal screens or the like. User interface 502 may incorporate switch 202 (above) or be a separate interface. Using interface 500, more complex rental cost control can be done. For example, if rental asset is shut down and confirmed, when a new user attempts to restart the asset, processor 200 may cause display 504 to request authorization or billing information. The operator would input the appropriate information via input 502. In this case, processor 200 will include an interlock to inhibit asset 102 from starting or restarting absent an authorized code.

1. A method of providing a rental status indication relating to a rental asset, comprising:
providing an operator initiated rental asset completion signal to a processor associated with the rental asset;
on receiving the rental asset completion signal at the processor, determining whether the rental asset is not in use;
if it is determined the rental asset is not in use, generating a rental status signal; and
transmitting the rental status signal.

2. The method of claim 1, wherein transmitting the rental status occurs in a batch transmission.

3. The method of claim 1, further comprising:
providing a rental completion confirmation signal to the operator.

4. The method of claim 1, wherein providing the rental asset completion signal comprises toggling a switch.

5. The method of claim 4, wherein the switch is selected from the group of switches consisting of: a throw switch, a push button switch, an electronic switch, and a software switch.

6. The method of claim 1, wherein the step of transmitting the rental signal occurs over a wireless communication network.

7. The method of claim 1, wherein the step of determining whether the rental asset is not in use comprises sensing at least one rental asset operating characteristics.

8. The method of claim 7, wherein the at least one rental asset operating characteristics is selected from a group of characteristics consisting of: engine rpm, wheel rotation, asset load, battery current, alternator current, engine temperature, exhaust, or oil pressure.

9. The method of claim 1, further comprising:
continuing to determine whether the rental asset remains not in use;
if it is determined the rental asset use is resumed, transmitting a new rental status signal to a rental agency indicating the rental asset use has resumed.

10. The method of claim 9, wherein transmitting the new rental status signal occurs after a predetermined time delay.

11. The method of claim 9, further comprising providing a rental resumed status indication to the operator, whereby the operator is alerted that the rental agency is aware of the rental asset's continued use.

12. The method of claim 9, further comprising requesting authorization for resuming the rental asset use.

13. The method of claim 12, further comprising the step of disabling the rental asset until the requested authorization is received.

14. The method of claim 9, further comprising the step of requesting an appropriate billing code.

15. An apparatus to provide an operator of a rental asset a mechanism to alert a rental agency that the use of the rental asset is finished, comprising:
a processor;
a switch coupled to the process to provide an operator initiated indication that the use of the rental asset is complete;
a sensor coupled to the processor to monitor at least one operating characteristic of the rental asset to provide confirmation that the use of the rental asset is complete; and
a transmitter coupled to the processor to transmit a rental status signal to the rental agency indicating the use of the rental asset is complete, whereby when an operator uses the switch to indicate the use of the rental asset is complete, the processor confirms that the monitored at least one operating characteristic indicates use of the rental asset is complete and based on the confirmation, causes the transmitter to transmit the rental status signal indicating the use of the rental asset is complete.

16. The apparatus of claim 15, wherein the transmitter transmits rental status instantly.

17. The apparatus of claim 15, wherein the sensor monitors at least one operating characteristic selected from the group of characteristics consisting of: engine rpm, wheel rotation, asset load, battery current, alternator current, engine temperature, exhaust, or oil pressure.

18. The apparatus of claim 15, wherein the switch is selected from the group of switches consisting of: a throw switch, a push button switch, an electronic switch, and a software switch.

19. The apparatus of claim 15, further comprising a status indicator, whereby the status indicator indicates the status of the rental asset.

20. The apparatus of claim 15, further comprising a receiver, the receiver to receive a confirmation signal from the rental agency confirming the rental agency has received the rental status signal.

21. The apparatus of claim 20, whereby the status indicator indicates the rental agency confirmation.

22. The apparatus of claim 20, whereby if the sensor indicates rental asset use resumption, the processor causes a new rental status signal to be transmitted to the rental agency by the transmitter and the status indicator indicates the rental asset use has resumed.

23. An apparatus to provide an operator of a rental asset a mechanism to alert a rental agency that a status of the rental asset has changed, comprising:
a processor;
a user interface coupled to the processor, the user interface having an input and a display; to provide an operator initiated indication that the use of the rental asset is complete;
a sensor coupled to the processor, the sensor monitors at least one operating characteristic of the rental asset to provide confirmation that the use of the rental asset is complete; and
a transmitter coupled to the processor to transmit a rental status signal to the rental agency indicating the use of the rental asset is complete, whereby
an operator can input that use of the rental asset is complete, the processor confirms the monitored at least one operating characteristic indicates use of the rental asset is complete and based on the confirmation, causes the transmitter to transmit the rental status signal indicating the use of the rental asset is complete.

24. The apparatus of claim 23, wherein if the sensor indicates rental asset use resumption, the processor requests authorization.

25. The apparatus of claim 23, wherein the processor disables the rental asset until an authorization is input.
